(19) United States
(12) Patent Application Publication
(10) Pub. No.: US 2015/0084875 A1
(43) Pub. Date: Mar. 26, 2015

(54) ENHANCED HAPTIC FEEDBACK FOR HANDHELD MOBILE COMPUTING DEVICES

(71) Applicants: Min LIU, Portland, OR (US); Steven L. PEARCE, Portland, OR (US)

(72) Inventors: Min LIU, Portland, OR (US); Steven L. PEARCE, Portland, OR (US)

(21) Appl. No.: 14/038,083

(22) Filed: Sep. 26, 2013

(51) Int. Cl. G06F 3/01; G06F 3/041

(52) U.S. Cl. CPC G06F 3/016; G06F 3/041
USPC 345/173

(57) ABSTRACT

Embodiments of the invention describe systems, apparatuses and methods for providing enhanced haptic feedback for handheld mobile computing devices. Embodiments of the invention detect a user touch input on a touchscreen input/output (I/O) interface of a handheld mobile computing device. One or more characteristics of the user touch input are determined, including one or more of a duration of the user touch input, a direction of the user touch input, or a force applied during the user touch input. A control signal comprising one or more pulses is generated to drive one or more actuators included in the handheld mobile computing device to generate an adjustable haptic effect, wherein the control signal is generated based, at least in part, on the determined one or more characteristics of the user touch input.

### FIELD

Embodiments of the present invention generally pertain to computing devices and more specifically to haptic feedback for handheld mobile computing devices.

### BACKGROUND

Handheld mobile computing devices are typically capable of providing some limited form of tactile feedback (i.e., “haptic feedback” or “haptic effects”). Tactile feedback may be used to provide notifications to the user or as output of an application in response to a user touch input (typically via a touchscreen interface). Existing solutions pre-define this tactile feedback to be fixed across all uses, regardless of the variations of touch-based input. In other words, tactile feedback for handheld mobile computing devices is fixed regardless of how a user varies his touch-based input (e.g., strength of touch, duration, etc.).

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of computing components for providing enhanced haptic feedback according to an embodiment of the invention.

FIG. 2A and FIG. 2B are illustrations of a user utilizing a handheld mobile computing device to generate haptic feedback according to an embodiment of the invention.

FIG. 3 is a block diagram of computing components for providing enhanced haptic feedback according to an embodiment of the invention.

FIG. 4 is an illustration of a user utilizing a handheld mobile computing device to generate haptic feedback according to an embodiment of the invention.

FIG. 5 is a flow diagram of a process for generating haptic feedback according to an embodiment of the invention.

FIG. 6 is an illustration of several varying electrical control signals to provide different haptic feedback responses according to an embodiment of the invention.

FIG. 7 is a block diagram of computing components to support enhanced haptic feedback according to an embodiment of the invention.

Descriptions of certain details and implementations follow, including a description of the figures, which may depict some or all of the embodiments described below, as well as a discussion of other potential embodiments or implementations of the inventive concepts presented herein. An overview of embodiments of the invention is provided below, followed by a more detailed description with reference to the drawings.

### DETAILED DESCRIPTION

Embodiments of the invention describe apparatuses, systems and methods for generating responsive haptic feedback for handheld mobile computing devices. Throughout this specification, several terms of art are used. These terms are to take on their ordinary meaning in the art from which they come, unless specifically defined herein or the context of their use would clearly suggest otherwise. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

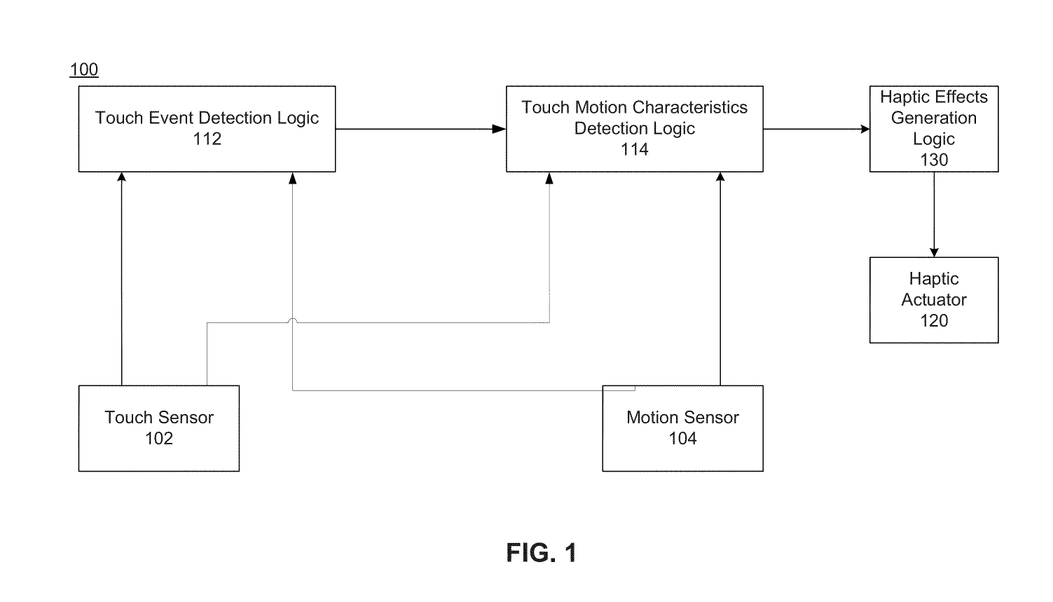

FIG. 1 is a block diagram of computing components for providing enhanced haptic feedback according to an embodiment of the invention. Haptic feedback (alternatively referred to herein as “haptic effects,” “tactile effects,” or “tactile feedback”) refers to touch sensory feedback provided to a user of a mobile computing device by applying forces, vibrations and/or motions onto some parts of the device to be felt by the user. It should be noted that even though examples described below utilize force based haptic feedback, non-force based haptic feedback may be used in other embodiments of the invention. As described below, embodiments of the invention create real time haptic effects that dynamically respond to user touch interaction—i.e., a mechanism to produce true haptic responsiveness for a handheld mobile computing device.

In this embodiment, some components of handheld mobile computing device 100 are shown, including touch sensor 102, motion sensor 104, touch event detection logic (i.e., ‘logic’ meaning software, hardware, or firmware, alone or in any combination) 112, touch motion characteristics detection logic 114, haptic effects generation logic 130, and actuator 120; said actuator may electrically drive a mass element (e.g., counterweight in the eccentric rotating mass motor, not shown) to apply forces, vibrations and/or motions onto the frame or other parts of device 100 to be felt by the user. As used herein, the phrase “handheld mobile computing device” may describe a smartphone, a personal digital assistant (PDA) a tablet computer (e.g., a tablet computer with a touch screen interface), or any similar device. The phrase “handheld mobile computing device” may also include wearable computing devices, such as a smart watch, smart head phone, or any similar device that can be worn or attached to human body. These illustrated components generate haptic effects that dynamically respond to a user's interaction with device 100, in real time. The generated haptic effects change based on the touch characteristics of the user's interaction with the device, as described below.

Touch event detection logic 112 may detect the occurrence of a user touch input via sensor 102 (e.g., on a touchscreen of a mobile computing device) and/or motion sensor 104, while touch motion characteristics detection logic 114 may detect/determine characteristics of the user's touch (e.g., force applied, speed, duration, etc.) by receiving data from device motion sensor 104, and/or touch sensor 102. The touch event detection logic 112 and the touch motion characteristics detection logic 114 are used to generate haptic effect by the haptic effects generation logic 130 according to how hard the user touched the device, how fast the user moved his finger on the device, how hard the user pushed a displayed object on a touchscreen interface (e.g., an icon or cursor), etc. These logic components may send data to actuator 120 such that the actuator generates a haptic effect that a user can perceive.

Thus, device 100 responds with haptic feedback via actuator 120 dependent on how the user touches the device. For example, when a user “pushes” the device, haptic feedback is generated so that the user feels the device pushes back—i.e., the strength of the haptic feedback increases in real time as the strength of the user's touch input increases; when the user stops pushing, the haptic feedback stops.

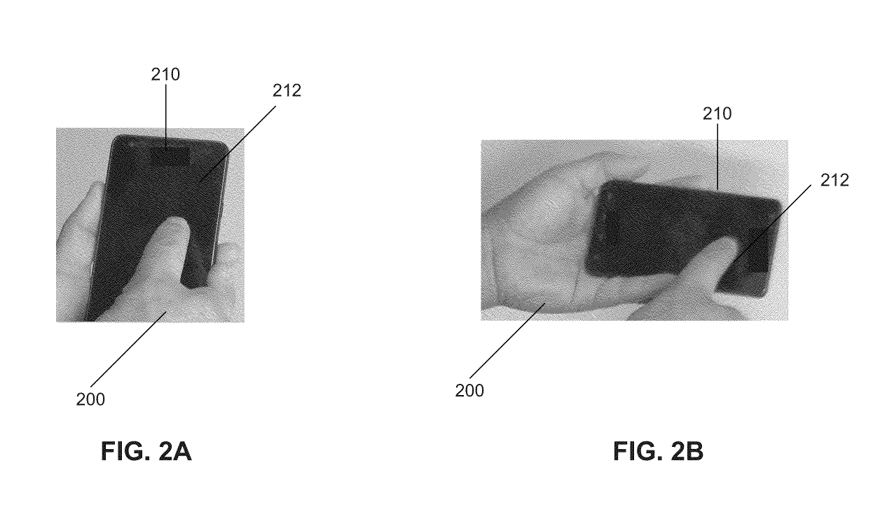

FIG. 2A and FIG. 2B are illustrations of a user utilizing a handheld mobile computing device to generate haptic feedback according to an embodiment of the invention. In these illustrations, user 200 is shown to utilize handheld mobile computing device 210, which in this example is a smartphone device.

In embodiments of the invention, there may be multiple ways to detect a touch event. In one embodiment, the touch detection logic of device 210 monitors touchscreen 212—i.e., when user 200 touches the touchscreen, the touch detection logic captures the touch event. In some embodiments, the touch detection logic further monitors touch sensors on the sides and back of device 210—i.e., when user 200 touches the device back or sides, the touch detection logic captures the touch event(s). In some embodiments, the touch detection logic utilizes a motion sensor 104 to detect a touch event—i.e., when user 200 pushes the device anywhere, the motion sensor 104 captures the touch event. The motion sensor 104 may be an accelerometer, a gyroscope or any other type of motion sensor.

Similarly, embodiments of the invention may utilize multiple processes and sensors to detect touch motion characteristics. The motion of device 210 generated by user 200 touching the device may be interpreted as an indicator of how hard the user touches the device. For example, as shown in FIG. 2A, device 210 is shown to be held by user 200 and be touched on the touch screen 212. Depending on how hard the user 200 touches the device 210 on the touch screen 212, the area and/or pressure at the touch points on the touch screen can vary and can be captured by the touch sensor and used to indicate the touch strength of the motion characteristics. In another example as shown in FIG. 2B, when user 200 holds and touches the device 210, the device motion caused by the user's interaction with the device can be captured by a motion sensor, such as an accelerometer, to detect the linear acceleration of the device motion from the force of the touch input. For example, by reading out the accelerometer data, the peak value of the sensor data can be found and normalized to get the determined strength of the user's touch.

The motion from the user interaction can also be captured by a gyrometer or gyroscope, to detect the angular velocity of the motion caused by user 200 touching the device 210. The angular change of device 210 caused by user 200 touching the device 210 can be detected from reading the sensor data and can be normalized to get the determined strength of the user's touch. This process is especially useful in the illustrated embodiment as user 200 holds the device 210 in one hand and uses his other hand to touch device 210. An example usage may be pushing an object into the display and away from the user in a three-dimensional (3D) game application. The strength of the user's touch is determined based on the detected angular change of the device.

The touch strength is then used as a modifier to the haptic effects of device 210. For example, in some embodiments, the harder user 200 pushes, the stronger the user feels the haptic feedback—giving the user a feeling of that device 210 pushing back. When the user stops pushing—even with finger still touching the device, the haptic feedback may cease. When the user resumes pushing, the haptic feedback may resume.

Thus, in this embodiment, true haptic applications may be implemented to provide responsive real-time feedback. This embodiment may be useful for 3D applications; when a user is pushing an object perpendicular to the device surface “into the display” the user feels the “physical” resistance of the movement. The speed of a user touch input may also be detected and may be used as a modifier to the haptic effects produced by device 210. It may be implemented such that when user 200 moves his finger faster across touchscreen 212, device 210 produces stronger haptic effects—making the user feel more resistance. This embodiment may be useful for two dimensional (2D) user interface (UI) or gaming applications, such as moving an object in the 2D space, turning a rotary wheel, or swiping a slider.

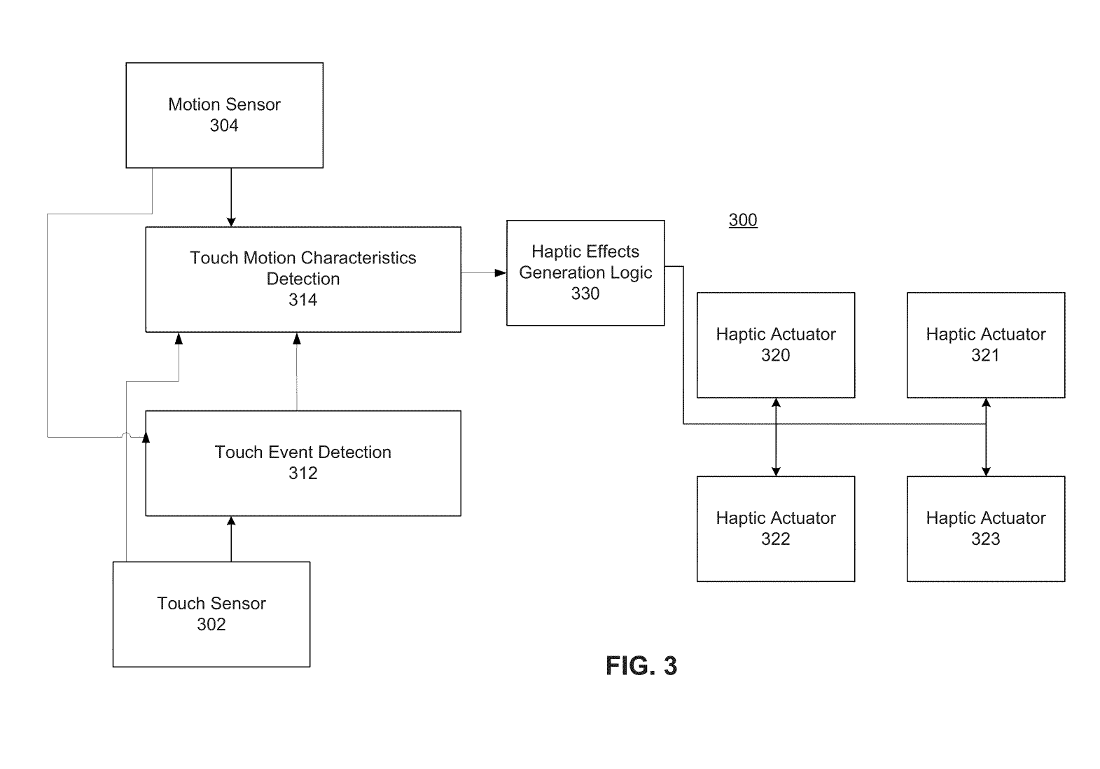

FIG. 3 is a block diagram of computing components for providing enhanced haptic feedback according to an embodiment of the invention. In this embodiment, some components of device 300 are shown, including touch sensor 302, motion sensor 304, touch event detection logic 312, touch motion characteristics detection logic 314, haptic effects generation logic 330, and actuators 320-323 for producing haptic feedback for the device. These described components generate haptic effects that dynamically respond to a user's interaction with device 300, in real time. The generated haptic effects change based on touch motion characteristics of the user's interaction with the device.

Multiple actuators 320-323 may be placed in different locations throughout device 300, and may be selectively activated based on a user's touch input. For example, multiple actuators may be activated to produce a stronger tactile feedback in response to a user input. In another example, actuators 320-323 may be activated based on how close a user's touch input is with respect to the position of the actuator within device 300.

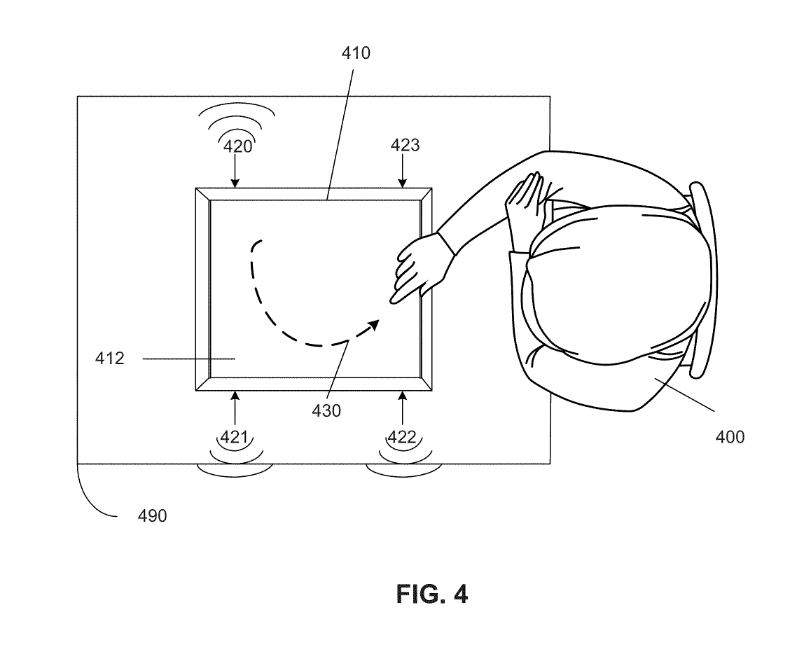

FIG. 4 is an illustration of a user utilizing a handheld mobile computing device to generate haptic feedback according to an embodiment of the invention. In this illustration, user 400 is shown to utilize handheld mobile computing device 410, represented as a tablet computing device, placed on tabletop 490.

In contrast to the example usage illustrated in FIG. 2 and described above, when a handheld mobile computing device is placed about a stationary surface, such as tabletop 490, motion sensor elements may not detect the touch characteristics of the user's input, as device 410 is unlikely to move. Thus, in some embodiments, touch motion characteristics for inputs on touch sensors on the front panel, or on the back, or the sides may be determined by measuring the touch pressure via a pressure-sensitive layer overlaying touchscreen display 412 to or by measuring the length of time and/or touch area of the user's touch input (i.e., the stronger a user's touch input, the more area of his finger may be pressed on the touchscreen/touch sensor and the longer the user may hold his finger on the touchscreen/touch sensor). In another embodiment, microphones may be used to capture the sound produced by user touching the device and to indicate the motion characteristics of user's interaction with the device. In yet another embodiment, ultra-sound sensors may be used to capture the user's touch motion characteristics.

In this embodiment, device 410 includes plurality of vibrating elements 420-423, and are selectively activated based on user touch input 430 on touchscreen 412, which is shown to comprise a semi-circular motion. Thus, in this example, vibrating element 420 is activated with user initiates gesture 430, then vibrating element 421 is activated while vibrating element 420 is deactivated, and so forth until gesture 430 is completed. In this example, because user touch input 430 is never proximate to vibrating element 423, said vibrating element is never activated.

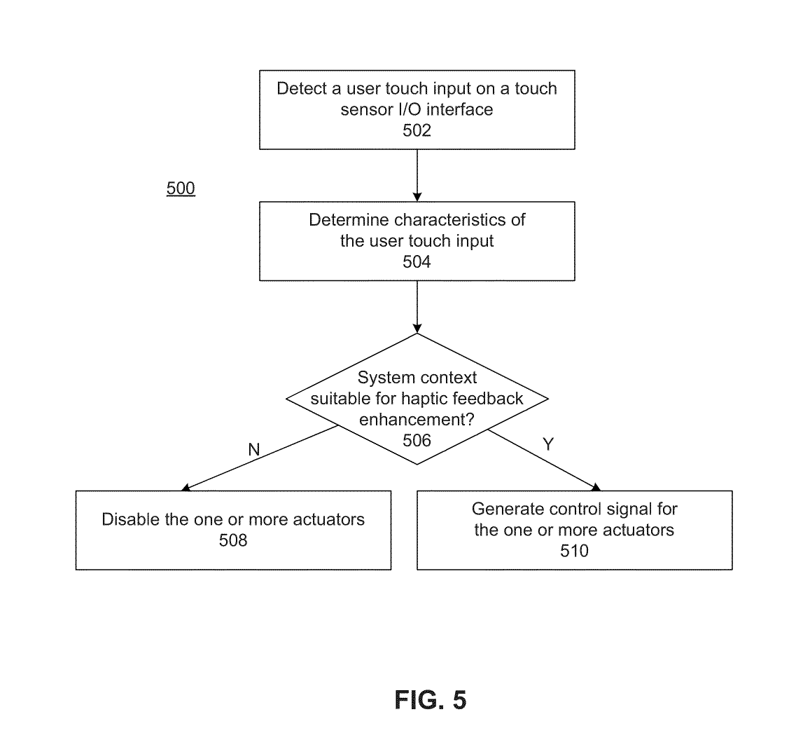

FIG. 5 is a flow diagram of a process for generating haptic feedback according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 500 includes operations for detecting a user touch input on a touch sensor input/output (I/O) interface of a handheld mobile computing device, 502. The touch sensor I/O interface may be on a touchscreen interface, or on any other external portion of the device (e.g., sides, back), or utilizing motion sensor, microphone, ultra-sound sensor. In response to detecting the user touch input, characteristics of the user touch input including one or more of the duration of the touch, the direction of the touch, or the strength of the touch may be determined, 504.

In some embodiments, the handheld mobile computing device further includes an accelerometer, and determining the force applied during the user touch input is based, at least in part, on a linear acceleration of the handheld mobile computing device during the user touch input. In some embodiments, the handheld mobile computing device further includes a gyroscope, and determining the force applied during the user touch input is based, at least in part, on an angular velocity of the handheld mobile computing device during the user touch input.

In some embodiments, the touch sensor I/O interface comprises a pressure sensor to measure the force applied during the user touch input; however, in other embodiments without a pressure sensor, determining the force applied during the user touch input is based, at least in part, on a duration of the user touch input or a contact area of the user touch input on the touch sensor I/O interface. This may also occur in embodiments including a motion detector (e.g., an accelerometer, a gyroscope) when the handheld mobile computing device is used in a stationary manner (e.g., place on a tabletop or other similarly stable surface during use).

A determination is made as to whether a current user context comprises an application for generating enhanced haptic feedback, 506. If the application is not suitable for haptic feedback, no feedback is generated 508. If haptic feedback is appropriate for the current application context, a signal comprising one or more pulses to drive one or more actuators is generated based, at least in part, on determined characteristics of the user touch input, 510. The one or more actuators generate an adjustable haptic effect on the handheld mobile computing device.

In some embodiments, the handheld mobile computing device includes a plurality of actuators, and generating the control signal to drive the actuators includes operations for selectively activated each of the plurality of actuators based on the determined characteristics of the user touch input. For example, each of the plurality of actuators may be activated based, at least in part, on a determined location of the user touch input on the touchscreen I/O interface, or a quantity of the plurality of actuators may be activated based, at least in part, on the determined force applied during the user touch input (i.e., the stronger the user touch input, the more actuators that are activated).

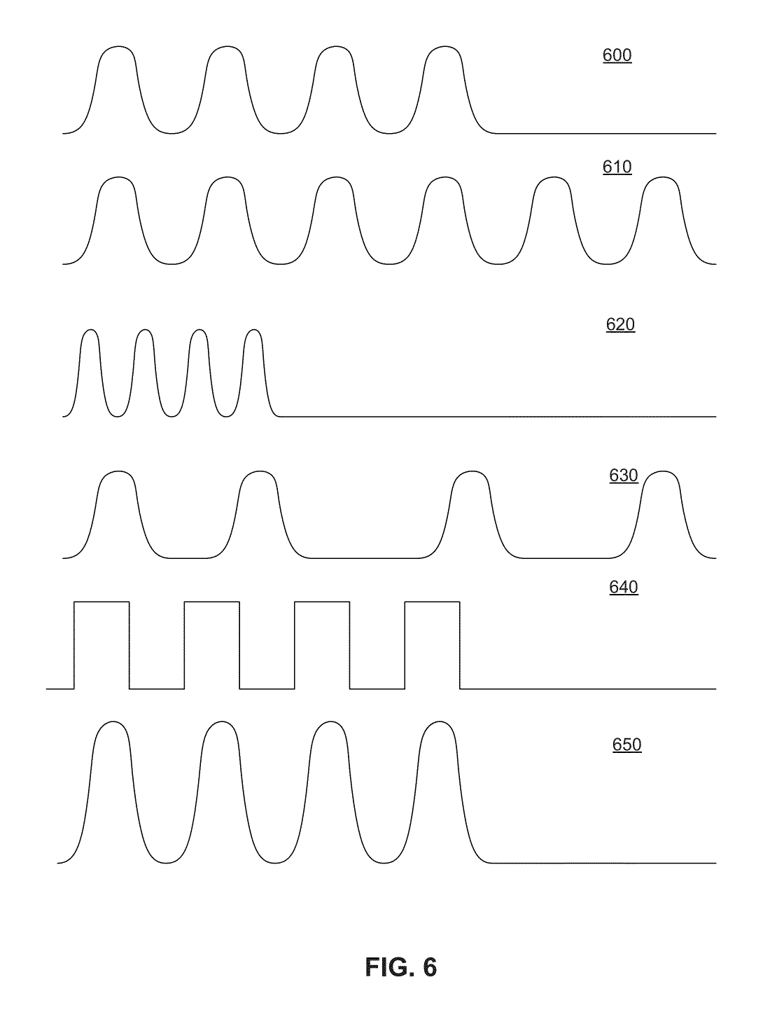

In some embodiments, generating the control signal for the one or more actuators of a handheld mobile computing device includes modifying at least one of a duration, a frequency, a period, a waveform shape, or an amplitude of a default control signal comprising or one or more pulses to generate the control signal. FIG. 6 is an illustration of several varying electrical control signals to provide different haptic feedback responses according to an embodiment of the invention. Signal 600 represents a default (i.e., baseline) electrical signal for driving an actuator of a mobile device. In this example, said signal comprises a plurality of pulses sent to the actuator in order to generate haptic feedback (i.e., vibrations) to a user. In response to analyzing touch motion characteristics, the haptic effects may be adjusted to match the touch motion characteristics. In this example, said touch motion characteristics are used to modify signal 600.

Thus, in this example, signal 610 comprises a modified version of signal 600 containing more pulses in response to a prolonged user touch input. Signal 620 comprises a modified version of signal 600 having a high frequency in response to a fast user touch input. Signal 630 comprises a modified version of signal 600 having differing time periods between pulses in response to a slow user touch input. Signal 640 comprises a modified version of signal 600 shaped as a square curve to provide a flatter haptic response. Signal 650 comprises a modified version of signal 600 having a higher amplitude in response to a stronger user touch input. Any of the above described modifications may also be combined based on characteristics of the user touch input—e.g., a strong, fast user input touch may result in a generated signal having a higher amplitude and frequency compared to signal 600.

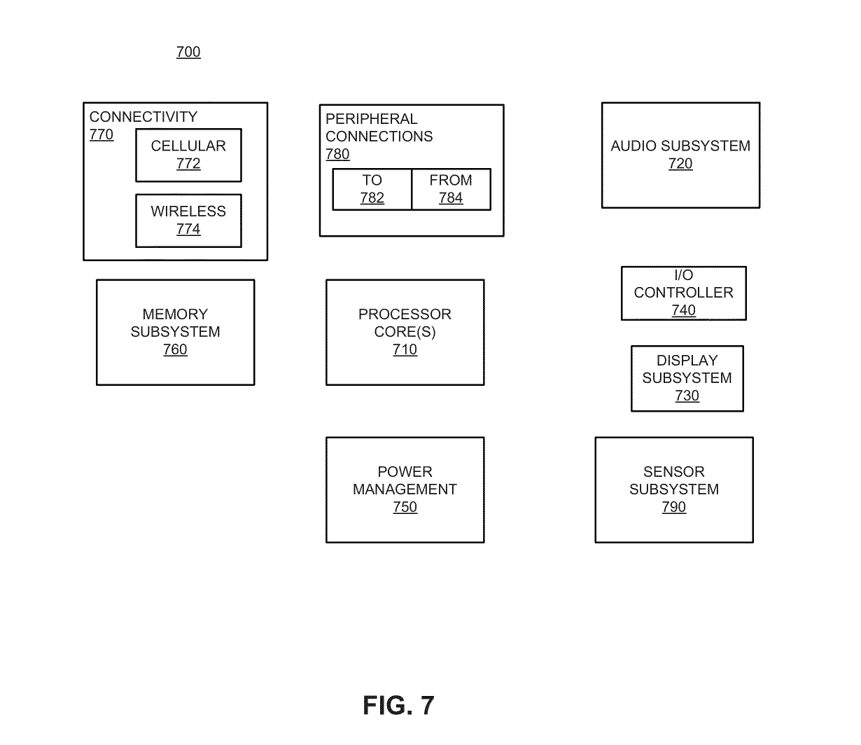

FIG. 7 is a block diagram of computing components to support enhanced haptic feedback according to an embodiment of the invention. It will be understood that certain of the components are shown generally, and not all components of such a device are shown in device 700. Furthermore, it will be understood that any of the illustrated components may be discrete components or may be components included on a system on a chip (SoC) integrated circuit (IC), and may be communicatively coupled through any direct or indirect means.

Device 700 includes one or more processor cores 710, which performs the primary processing operations of device 700. Each of processor core(s) 710 can be SoC components, or can be included in one or more physical devices, such as single or multi-core microprocessors, application processors, microcontrollers, programmable logic devices, or other processing means. The processing operations performed by processor core(s) 710 include the execution of an operating platform or operating system on which applications and/or device functions are executed. The processing operations include operations related to I/O (input/output) with a human user or with other devices, operations related to power management, and/or operations related to connecting device 700 to another device. The processing operations may also include operations related to audio I/O and/or display I/O.

In one embodiment, device 700 includes audio subsystem 720, which represents hardware (e.g., audio hardware and audio circuits) and software (e.g., drivers, codecs) components associated with providing audio functions to the computing device. Audio functions can include speaker and/or headphone output, as well as microphone input via any of the audio jacks described above. Devices for such functions can be integrated into device 700, or connected to device 700. In one embodiment, a user interacts with device 700 by providing audio commands that are received and processed by processor core(s) 710.

I/O controller 740 represents hardware devices and software components related to interaction with a user. I/O controller 740 can operate to manage hardware that is part of audio subsystem 720 and/or display subsystem 730. Additionally, I/O controller 740 illustrates a connection point for additional devices that connect to device 700 through which a user might interact with the system. For example, devices that can be attached to device 700 might include microphone devices, speaker or stereo systems, video systems or other display device, keyboard or keypad devices, or other I/O devices for use with specific applications such as card readers or other devices.

As mentioned above, I/O controller 740 can interact with audio subsystem 720 and/or display subsystem 730. For example, input through a microphone or other audio device can provide input or commands for one or more applications or functions of device 700. Additionally, audio output can be provided instead of or in addition to display output. Display subsystem 730 includes a touchscreen, and thus the display device also acts as an input device, which can be at least partially managed by I/O controller 740. There can also be additional buttons or switches on device 700 to provide I/O functions managed by I/O controller 740. Sensor subsystem 790 may comprise any touch sensor (e.g., touch sensors in addition to the touchscreen of display subsystem 730) and/or motion detectors used to provide data for any of the enhanced haptic feedback processes described above.

In one embodiment, I/O controller 740 manages devices such as accelerometers, cameras, light sensors or other environmental sensors, or other hardware that can be included in device 700. The input can be part of direct user interaction, as well as providing environmental input to the system to influence its operations (such as filtering for noise, adjusting displays for brightness detection, applying a flash for a camera, or other features). In one embodiment, device 700 includes power management 750 that manages battery power usage, charging of the battery, and features related to power saving operation.

Memory subsystem 760 includes memory devices for storing information in device 700. Memory can include nonvolatile (state does not change if power to the memory device is interrupted) and/or volatile (state is indeterminate if power to the memory device is interrupted) memory devices. Memory 760 can store application data, user data, music, photos, documents, or other data, as well as system data (whether long-term or temporary) related to the execution of the applications and functions of system 700. Memory 760 further stores firmware images related to boot path operations, and thus may include DRAM devices to store said firmware images as described above.

Connectivity 770 includes hardware devices (e.g., wireless and/or wired connectors and communication hardware) and software components (e.g., drivers, protocol stacks) to enable device 700 to communicate with external devices. The device could be separate devices, such as other computing devices, wireless access points or base stations, as well as peripherals such as headsets, printers, or other devices.

Connectivity 770 can include multiple different types of connectivity. To generalize, device 700 is illustrated with cellular connectivity 772 and wireless connectivity 774. Cellular connectivity 772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity 774 refers to wireless connectivity that is not cellular, and can include personal area networks (such as Bluetooth), local area networks (such as Wi-Fi), and/or wide area networks (such as Wi-Max), or other wireless communication.

Peripheral connections 780 include hardware interfaces and connectors for implementing non-flash firmware storage support as described above, as well as software components (e.g., drivers, protocol stacks) to make peripheral connections. It will be understood that device 700 could both be a peripheral device (“to” 782) to other computing devices, as well as have peripheral devices (“from” 784) connected to it. Device 700 commonly has a “docking” connector to connect to other computing devices for purposes such as managing (e.g., downloading and/or uploading, changing, synchronizing) content on device 700. Additionally, a docking connector can allow device 700 to connect to certain peripherals that allow device 700 to control content output, for example, to audiovisual or other systems.

In addition to a proprietary docking connector or other proprietary connection hardware, device 700 can make peripheral connections 780 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

Embodiments of the invention describe a method and an of manufacture comprising a computer-readable non-transitory storage medium having instructions stored thereon to cause a processor to perform operations including detecting a user touch input on a touchscreen input/output (I/O) interface of a handheld mobile computing device, determining one or more characteristics of the user touch input, including one or more of a duration of the user touch input, a direction of the user touch input, a speed of the user touch input, or a force applied during the user touch input, and generating a control signal comprising one or more pulses to drive one or more actuators included in the handheld mobile computing device to generate an adjustable haptic effect, wherein the control signal is generated based, at least in part, on the determined one or more characteristics of the user touch input.

In some embodiments, generating the control signal comprises modifying at least one of a duration, a frequency, a period, a waveform shape, or an amplitude of a default control signal comprising or one or more pulses. The adjustable haptic effect on the handheld mobile computing device may be generated based, at least in part, on an application context of the handheld mobile computing device.

In some embodiments, the handheld mobile computing device comprises a plurality of actuators, and generating the control signal to drive the actuators comprises selectively activating one or more of the plurality of actuators based, at least in part, on the determined characteristics of the user touch input. In some of these embodiments, the one or more of the plurality of actuators is activated based, at least in part, on a determined location of the user touch input on the touchscreen I/O interface, or a quantity of the plurality of actuators is activated based, at least in part, on the determined force applied during the user touch input.

In some embodiments, the handheld mobile computing device further includes an accelerometer, and determining the force applied during the user touch input is based, at least in part, on a linear acceleration of the handheld mobile computing device during the user touch input. In some embodiments, the handheld mobile computing device further includes a gyroscope, and determining the force applied during the user touch input is based, at least in part, on an angular acceleration of the handheld mobile computing device during the user touch input.

The touchscreen I/O interface may include a pressure sensor to measure the force applied during the user touch input. In some embodiments, determining the force applied during the user touch input is based, at least in part, on a duration of the user touch input or a contact area of the user touch input on the touchscreen I/O interface.

Embodiments of the invention describe a handheld mobile computing device comprising, at least one touch sensor comprising a touchscreen input/output (I/O) interface, touch detection logic to detect a user touch input on the at least one touch sensor, touch motion logic to determine one or more characteristics of the user touch input, including one or more of a duration of the user touch input, a direction of the user touch input, a speed of the user touch input, or a force applied during the user touch input, one or more actuators to generate an adjustable haptic effect on the handheld mobile computing device, and control signal logic to generate a control signal comprising one or more pulses to drive the one or more actuators to generate the adjustable haptic effect based, at least in part, on the determined one or more characteristics of the user touch input. In some embodiments, said handheld mobile computing device includes an antenna, and radio frequency circuitry coupled to the antenna to receive signal data to be processed by the handheld mobile computing device.

In some embodiments, the control signal logic is to further modify at least one of a duration, a frequency, a period, a waveform shape, or an amplitude of a default control signal comprising or one or more pulses.

In some embodiments, the one or more actuators comprises a plurality of actuators, and the control signal logic to further selectively activate one or more of the plurality of actuators based, at least in part, on the determined characteristics of the user touch input. In some of these embodiments, the one or more of the plurality of actuators is activated based, at least in part, on a determined location of the user touch input on the touchscreen I/O interface, or a quantity of the plurality of actuators may be activated based, at least in part, on the determined force applied during the user touch input.

In some embodiments, the handheld mobile computing device includes an accelerometer, and the touch motion logic determines the force applied during the user touch input based, at least in part, on a linear acceleration of the handheld mobile computing device during the user touch input. In some embodiments, the handheld mobile computing device includes a gyroscope, and the touch motion logic determines the force applied during the user touch input based, at least in part, on an angular acceleration of the handheld mobile computing device during the user touch input.

In some embodiments, in the touchscreen I/O interface comprises a pressure sensor to measure the force applied during the user touch input. In some embodiments, the touch motion logic to determine the force applied during the user touch input is based, at least in part, on a duration of the user touch input or a contact area of the user touch input on the touchscreen I/O interface. In some embodiments, the at least one touch sensor comprises a plurality of touch sensors included on one or more of an exterior side or a rear-facing side opposite the touchscreen I/O interface.

Embodiments of the invention further describe logic that is at least partially implemented in hardware (e.g., digital logic, circuitry, etc.), the logic to detect a user touch input on a touchscreen input/output (I/O) interface of a handheld mobile computing device. The logic further determines one or more characteristics of the user touch input, including one or more of a duration of the user touch input, a direction of the user touch input, a speed of the user touch input, or a force applied during the user touch input, and generates a control signal comprising one or more pulses to drive one or more actuators included in the handheld mobile computing device to generate an adjustable haptic effect, wherein the control signal is generated based, at least in part, on the determined one or more characteristics of the user touch input.

In some embodiments, generating the control signal comprises the logic to modify at least one of a duration, a frequency, a period, a waveform shape, or an amplitude of a default control signal comprising or one or more pulses.

In some embodiments, generating the control signal to drive the actuators comprises the logic to selectively activate one or more of a plurality of actuators based, at least in part, on the determined characteristics of the user touch input. For example, a quantity of the plurality of actuators is activated based, at least in part, on the determined force applied during the user touch input.

In some embodiments, the logic determining the force applied during the user touch input is based, at least in part, on a duration of the user touch input or a contact area of the user touch input on the touchscreen I/O interface.

Various components referred to above as processes, servers, or tools described herein may be a means for performing the functions described. Each component described herein includes software or hardware, or a combination of these. Each and all components may be implemented as logic such as software modules, hardware modules, special-purpose hardware (e.g., application specific hardware, ASICs, DSPs, etc.), embedded controllers, hardwired circuitry, hardware logic, etc. Software content (e.g., data, instructions, configuration) may be provided via an article of manufacture including a non-transitory, tangible computer or machine readable storage medium, which provides content that represents instructions that can be executed. The content may result in a computer performing various functions/operations described herein.

A computer readable non-transitory storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable non-transitory storage medium may also include a storage or database from which content can be downloaded. Said computer readable medium may also include a device or product having content stored thereon at a time of sale or delivery. Thus, delivering a device with stored content, or offering content for download over a communication medium may be understood as providing an article of manufacture with such content described herein.

1. A handheld mobile computing device comprising:
at least one touch sensor comprising a touchscreen input/output (I/O) interface;
touch detection logic to detect a user touch input on the at least one touch sensor;
touch motion logic to determine one or more characteristics of the user touch input, including one or more of a duration of the user touch input, a direction of the user touch input, a speed of the user touch input, or a force applied during the user touch input;
one or more actuators to generate an adjustable haptic effect on the handheld mobile computing device; and
control signal logic to generate a control signal comprising one or more pulses to drive the one or more actuators to generate the adjustable haptic effect based, at least in part, on the determined one or more characteristics of the user touch input.

2. The handheld mobile computing device of claim 1, wherein the control signal logic to further modify at least one of a duration, a frequency, a period, a waveform shape, or an amplitude of a default control signal comprising or one or more pulses.

3. The handheld mobile computing device of claim 1, wherein the one or more actuators comprises a plurality of actuators, and the control signal logic to further selectively activate one or more of the plurality of actuators based, at least in part, on the determined characteristics of the user touch input.

4. The handheld mobile computing device of claim 3, wherein the one or more of the plurality of actuators is activated based, at least in part, on a determined location of the user touch input on the touchscreen I/O interface.

5. The handheld mobile computing device of claim 3, wherein a quantity of the plurality of actuators is activated based, at least in part, on the determined force applied during the user touch input.

6. The handheld mobile computing device of claim 1, further comprising:
an accelerometer; wherein the touch motion logic to determine the force applied during the user touch input is based, at least in part, on a linear acceleration of the handheld mobile computing device during the user touch input.

7. The handheld mobile computing device of claim 1, further comprising:
a gyroscope; wherein the touch motion logic to determine the force applied during the user touch input is based, at least in part, on an angular acceleration of the handheld mobile computing device during the user touch input.

8. The handheld mobile computing device of claim 1, wherein the touchscreen I/O interface comprises a pressure sensor to measure the force applied during the user touch input.

9. The handheld mobile computing device of claim 1, wherein the touch motion logic to determine the force applied during the user touch input is based, at least in part, on a duration of the user touch input or a contact area of the user touch input on the touchscreen I/O interface.

10. The handheld mobile computing device of claim 1, wherein the at least one touch sensor comprises a plurality of touch sensors included on one or more of an exterior side or a rear-facing side opposite the touchscreen I/O interface.

11. An article of manufacture comprising a computer-readable non-transitory storage medium having instructions stored thereon to cause a processor to perform operations including:
detecting a user touch input on a touchscreen input/output (I/O) interface of a handheld mobile computing device;
determining one or more characteristics of the user touch input, including one or more of a duration of the user touch input, a direction of the user touch input, a speed of the user touch input, or a force applied during the user touch input; and
generating a control signal comprising one or more pulses to drive one or more actuators included in the handheld mobile computing device to generate an adjustable haptic effect, wherein the control signal is generated based, at least in part, on the determined one or more characteristics of the user touch input.

12. The article of manufacture of claim 11, wherein generating the control signal comprises:
modifying at least one of a duration, a frequency, a period, a waveform shape, or an amplitude of a default control signal comprising or one or more pulses.

13. The article of manufacture of claim 11, wherein the handheld mobile computing device comprises a plurality of actuators, and generating the control signal to drive the actuators comprises:
selectively activating one or more of the plurality of actuators based, at least in part, on the determined characteristics of the user touch input.

14. The article of manufacture of claim 13, wherein the one or more of the plurality of actuators is activated based, at least in part, on a determined location of the user touch input on the touchscreen I/O interface.

15. The article of manufacture of claim 13, wherein a quantity of the plurality of actuators is activated based, at least in part, on the determined force applied during the user touch input.

16. The article of manufacture of claim 11, wherein the handheld mobile computing device further includes an accelerometer, and determining the force applied during the user touch input is based, at least in part, on a linear acceleration of the handheld mobile computing device during the user touch input.

17. The article of manufacture of claim 11, wherein the handheld mobile computing device further includes a gyroscope, and determining the force applied during the user touch input is based, at least in part, on an angular acceleration of the handheld mobile computing device during the user touch input.

18. The article of manufacture of claim 11, wherein the touchscreen I/O interface comprises a pressure sensor to measure the force applied during the user touch input.

19. The article of manufacture of claim 11, wherein determining the force applied during the user touch input is based, at least in part, on a duration of the user touch input or a contact area of the user touch input on the touchscreen I/O interface.

20. The article of manufacture of claim 11, further comprising:
generating the adjustable haptic effect on the handheld mobile computing device based, at least in part, on an application context of the handheld mobile computing device.

21. A device comprising:
logic, the logic at least partially implemented in hardware, the logic to:
detect a user touch input on a touchscreen input/output (I/O) interface of a handheld mobile computing device;
determine one or more characteristics of the user touch input, including one or more of a duration of the user touch input, a direction of the user touch input, a speed of the user touch input, or a force applied during the user touch input; and
generate a control signal comprising one or more pulses to drive one or more actuators included in the handheld mobile computing device to generate an adjustable haptic effect, wherein the control signal is generated based, at least in part, on the determined one or more characteristics of the user touch input.

22. The device of claim 21, wherein generating the control signal comprises:
modifying at least one of a duration, a frequency, a period, a waveform shape, or an amplitude of a default control signal comprising or one or more pulses.

23. The device of claim 21, wherein generating the control signal to drive the actuators comprises:
selectively activating one or more of a plurality of actuators based, at least in part, on the determined characteristics of the user touch input.

24. The device of claim 23 wherein a quantity of the plurality of actuators is activated based, at least in part, on the determined force applied during the user touch input.

25. The device of claim 21, wherein determining the force applied during the user touch input is based, at least in part, on a duration of the user touch input or a contact area of the user touch input on the touchscreen I/O interface.
